(19) United States
(12) Patent Application Publication
(10) Pub. No.: US 2019/0172364 A1
(43) Pub. Date: Jun. 6, 2019

(54) TOOL FOR USE WITH A TRACING DEVICE

(71) Applicant: Danny Ray Pate, Kingsport, TN (US)

(72) Inventor: Danny Ray Pate, Kingsport, TN (US)

(21) Appl. No.: 15/832,873

(22) Filed: Dec. 6, 2017

(51) Int. Cl. G09B 11/00

(52) U.S. Cl. CPC G09B 11/00; B43L 1/00

(57) ABSTRACT

A tool for use with known tracing devices such as that sold originally by The Ohio Art Company under the trademark Etch-a-Sketch® is described. The tool of the present invention includes (i) first and second overlays, each for cooperation respectively with first and second rotatable knobs and each including circumferentially arranged visual guide indicia on a top surface thereof; (ii) first and second visual guide indicia position indicators, each including visual guide positioning indicia on a top surface and wherein said guide positioning indicia cooperate with circumferentially arranged visual guide indicia to indicate rotational positions of first and second rotatable knobs; and (iii) at least one visually readable guide indicia position instruction set including a sequenced set of steps for rotation of said first and second rotatable knobs based on the cooperation of guide positioning indicia and circumferentially arranged visual guide indicia.

### FIELD OF THE INVENTION

The present invention generally relates to the field of drawing or sketching devices, more specifically to a tool for use with drawing or sketching devices which assists the device user in the drawing and production of sketches, figures and the like.

### BACKGROUND OF THE INVENTION

U.S. Patent Nos. 3,055,113 and 3,760,505, the description and contents of which are hereby incorporated herein by reference, describe a popular and commercially successful tracing device sold originally by The Ohio Art Company under the trademark Etch-a-Sketch®. The tracing device includes a transparent tracing surface and a plastic frame or cover for holding the plate against the walls of a box in which is enclosed a fine metallic powder that coats the inner surface of the transparent glass top or plate to render it opaque. Also enclosed in the box is a stylus which presses against this inner surface of the glass plate and scrapes the powder therefrom to produce a line and a mechanism for movably operating the stylus. The mechanism for operating the stylus includes two rotatable knobs on the front face of the device, one on the left side of the screen and one on the right, that are mounted to shafts which connect to the mechanism inside the box. When the left knob is rotated by a user, the stylus is moved left or right. When the right knob is rotated by a user, the stylus is moved the upward or downward. By rotating the two knobs simultaneously or sequentially at various speeds and in various directions, a user of the device may cause the stylus to draw lines, designs, words, letters or the like on the inner surface of the transparent top plate which are viewable to the device user. When the design and/or lines are to be removed the box is then shaken, such as for example when the box is turned upside down, so that the powder again will cover the places where it has been scraped off the plate.

Despite the commercial success if this tracing device and those like it, one can readily appreciate a number of drawbacks and shortcomings. For example, users may struggle to produce drawings that meet their expectations in terms of quality and artistic appearance and become disheartened. Even if the result is acceptable to the user, the amount of time invested in achieving that result can detract from an otherwise positive experience. These can lead to user disappointment, shortened periods of use and, ultimately, loss of interest in the device and disuse. Further, drawings that are deemed particularly attractive or artistic are not easily reproducible once the image is erased, which presents particular challenges if others wish to use the device immediately after a drawing is complete or a drawing is inadvertently erased when the device is accidentally tilted.

In the interest of generating drawings of improved artistic quality using these tracing devices, software that provides for computer control of the rotation of the device knobs or shafts, such as that commercially offered under the trade name EtchABot™, has been created. Such software, while useful, completely removes all manual artistic influence from use of the device, negates the improvements in motor skills, dexterity and hand-eye coordination that can be achieved by use of the device and nullifies any positive fulfillment and feelings of achievement that can come from creating a drawing by hand.

A continuing need therefore exists for a tool usable with such a tracing device that facilitates manual production of visually attractive, artistic and reproducible drawings without disabling user motor skill and dexterity improvements achievable by use of the tracing device.

### SUMMARY OF THE INVENTION

In a first aspect, the present invention is directed to a tool for use with a tracing device that includes an enclosure with a top face; a transparent top plate; and first and second rotatable knobs. The tool of the present invention includes (i) first and second overlays for cooperation respectively with first and second rotatable knobs that each include circumferentially arranged visual guide indicia on a top surface thereof; (ii) first and second visual guide indicia position indicators, each visual guide indicia position indicator including guide positioning indicia on a top surface and wherein the guide positioning indicia cooperate with said circumferentially arranged visual guide indicia to indicate rotational positions of the first and second rotatable knobs; and (iii) at least one visually readable guide indicia position instruction set comprising a sequenced set of steps for rotation of the first and second rotatable knobs based on cooperation of the guide positioning indicia and the circumferentially arranged visual guide indicia.

In a second aspect, the present invention is directed to an improved tracing device that includes (i) a tracing device with an outer enclosure having a top face, a transparent top plate, a first rotatable knob and a second rotatable knob; and (ii) a tool that includes tool of the present invention includes (i) first and second overlays for cooperation respectively with first and second rotatable knobs that each include circumferentially arranged visual guide indicia on a top surface thereof; (ii) first and second visual guide indicia position indicators, each visual guide indicia position indicator including guide positioning indicia on a top surface and wherein the guide positioning indicia cooperate with said circumferentially arranged visual guide indicia to indicate rotational positions of the first and second rotatable knobs; and (iii) at least one visually readable guide indicia position instruction set comprising a sequenced set of steps for rotation of the first and second rotatable knobs based on cooperation of the guide positioning indicia and the circumferentially arranged visual guide indicia.

Further aspects of the invention are as disclosed and claimed herein.

### BRIEF DESCRIPTION OF THE DRAWINGS

FIG. 1 is a top plan view of a prior art tracing device usable in conjunction with the tool of the present invention;

FIG. 2 is a perspective view of an embodiment of an overlay useful as the first and second overlays of the tool of the present invention;

FIG. 2a is a perspective view of another embodiment of an overlay useful as the first and second overlays of the tool of the present invention;

FIG. 2b is a perspective view of yet another embodiment of an overlay useful as the first and second overlays of the tool of the present invention;

FIG. 3a is a perspective view of an embodiment of a visual guide indicia position indicator useful as the first and second visual guide indicia position indicators of the tool of the present invention;

FIG. 3b is a perspective view of another embodiment of a visual guide indicia position indicator useful as the first and second visual guide indicia position indicators of the tool of the present invention; and

FIG. 4 is a top plan view of an embodiment of the visually readable guide indicia position instruction set with a sequenced set of steps for using the tool of the present invention; and

FIG. 5 is a top plan view of a tracing device with optional start point locators which may be included with the tool of the present invention.

### DETAILED DESCRIPTION

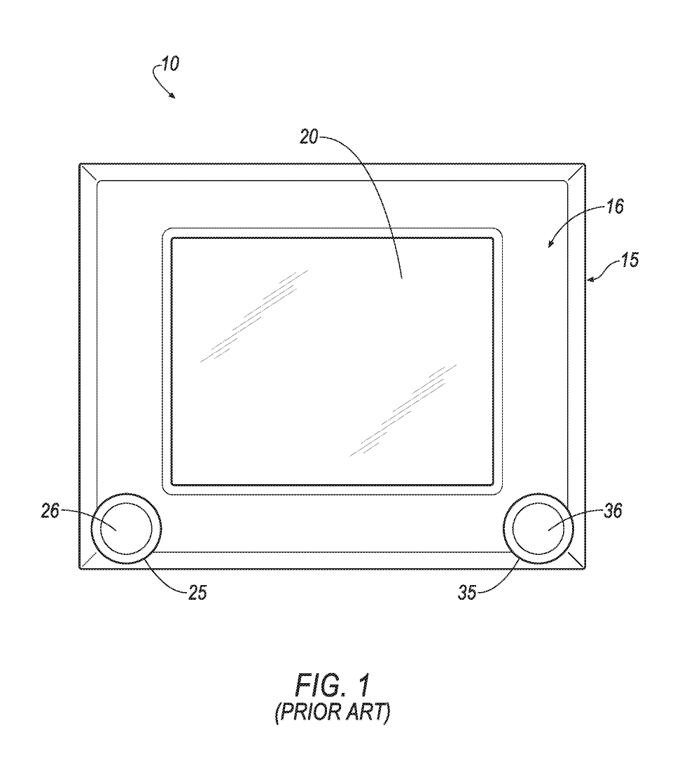

FIG. 1 provides a general illustration of a prior art tracing device 10 such as that commercially available from The Ohio Art Company under the trademark EtchaSketch®. The tracing device 10 includes an outer enclosure 15 with top face 16, a transparent top plate 20, a first rotatable knob 25 and a second rotatable knob 35. As discussed previously, a user of the device 10 may cause a stylus to draw lines, designs, words, letters or the like on the inner surface of the transparent top plate which are externally viewable to the device user by rotating the two knobs 25 and 35 simultaneously or sequentially at varying speeds and/or directions.

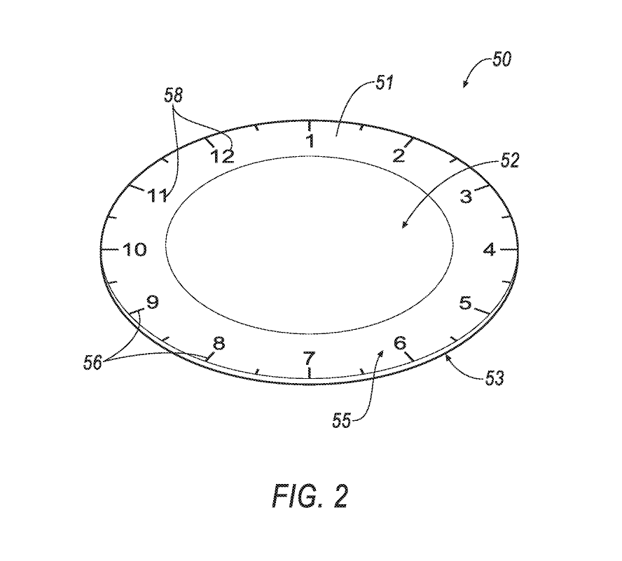

As shown in FIGS. 2 through 4, the tool of the present invention includes first and second overlays 50, each for cooperation respectively with first and second rotatable knobs 25 and 35 and each including circumferentially arranged visual guide indicia 55 on a top surface 51 thereof; first and second visual guide indicia position indicators 60, and each including visual guide positioning indicia 65 on a top surface 61 and wherein said guide positioning indicia 65 cooperate with circumferentially arranged visual guide indicia 55 to indicate rotational positions of first and second rotatable knobs 25 and 35; and (iii) at least one visually readable guide indicia position instruction set 70 comprising a written sequenced set of steps 80 for rotation of said first and second rotatable knobs based on the cooperation of guide positioning indicia 65 and circumferentially arranged visual guide indicia 55.

Circumferential guide indicia 55 preferably include evenly spaced lines, notches or the like 56 extending inward from the outer edge of each overlay and identifiers 58, typically numeric or alphabetic in form, corresponding to the lines or notches. Visual guide positioning indicia 65 preferably include an arrow, triangle, line, geometric shape or the like. Visual guide positioning indicia 65 cooperate with circumferentially arranged visual guide indicia 55 to indicate rotational positions of the first and second rotatable knobs 25 and 35. The term “visual” is used herein throughout to connote that the element being described is directly viewable or readable by a human being using the tool, for example by eyesight.

A first embodiment for the first and second overlays 50 and first and second visual guide position indicators 60 is depicted in FIG. 2. In this embodiment, the overlays 50 each further include an aperture 52 interior to the circumferential guide indicia 55. Apertures 52 are typically each circular with a diameter larger than the diameter of said first and second rotatable knobs 25 and 35 of device 10 such that overlays 50 are slidable over or around rotatable knobs 25 and 35 and preferably are mountable and when in use mounted on the top face 16 of enclosure 15 of the tracing device 10. Overlays may also each include an adhesive layer on the bottom surface 53 for mounting them to the top face 16 of enclosure 15 of the tracing device 10. Other mounting means such as hook-and-loop fasteners known in the art under the trade name Velcro™ are contemplated for mounting overlays 50 on the top face 16 of enclosure 15.

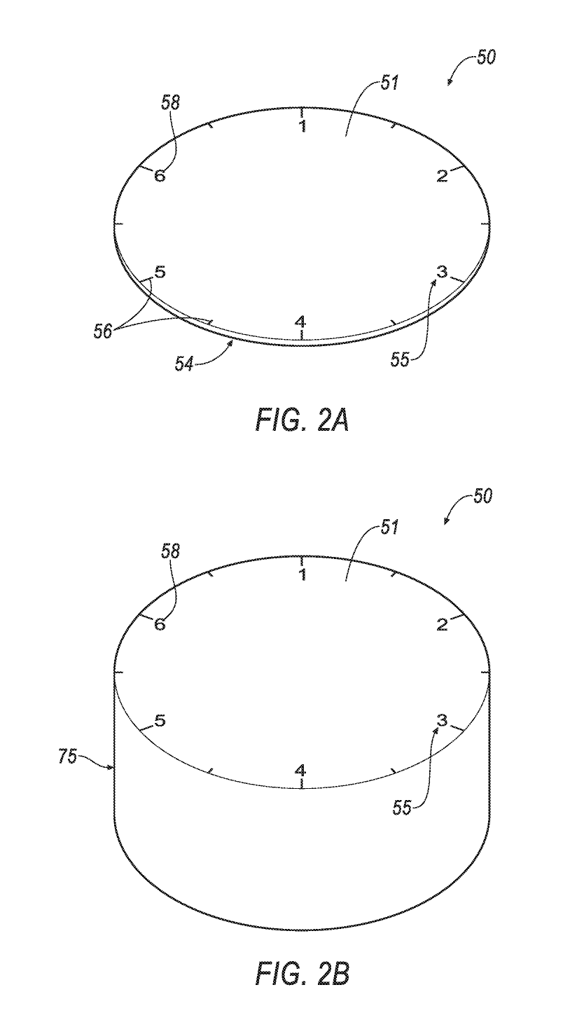

In the embodiment of the tool where the overlays are as shown in FIG. 2 and described immediately above, first and second visual guide positioning indicators 60, depicted in FIGS. 3A and 3B, are each attachable to and in use attached to knobs 25 and 35. In the embodiment depicted in FIG. 3A, visual guide indicia position indicator 60 may include an adhesive layer on a bottom surface 62 for attachment to top faces 26 and 36 of knobs 25 and 35. Though the visual guide indicia position indicator is generally shown in the embodiment depicted in FIG. 3A as circular to generally match the top faces 26 and 36 of knobs 25 and 35, it will be understood that other shapes, including the shape of a geometric shaped visual guide positioning indicia 65, may be contemplated. In another example, depicted in FIG. 3B, first and second visual guide positioning indicators 60 each include a cap 75 mountable and when in use fixedly mounted on and rotatable with each of first and second rotatable knobs 25 and 35. In another example (not shown), the tool first and second visual guide positioning indicators 60 each include replacement knobs which can be installed on device 10 as replacements for knobs 25 and 35.

Another embodiment of the tool of the present invention is depicted in FIGS. 2A, 2B and 3A. In this embodiment, first and second overlays 50 are each mountable and when in use mounted on respective first and second rotatable knobs 25 and 35. In this embodiment, first and second visual guide indicia position indicators 60 may include an adhesive on bottom surface 62 and are mountable and when in use mounted on top face 16 of enclosure 15 of tracing device 10. Though the visual guide indicia position indicator is generally shown in FIG. 3A as circular, it will be understood that other shapes, including the shape of a geometric shaped visual guide positioning indicia 65, may be contemplated. In this embodiment, first and second overlays 50 may for example (and as depicted in FIG. 2A) include an adhesive layer on bottom surface 54 and are mountable and mounted when in use on the top faces 26 and 36 of each of first and second rotatable knobs 25 and 35. In another example of this embodiment depicted in FIG. 2B, first and second overlays 50 each include a cap 75 mountable and mounted when in use on each of first and second rotatable knobs 25 and 35. In another example (not shown), the first and second overlays 50 each include replacement knobs which can be installed as replacements for knobs 25 and 35.

Overlays 50 as well as position indicators 60 may be formed from any material such as wood, cardboard, paper, label stock, plastic, multilayer laminated constructions or the like. One of ordinary skill will appreciate that the selection of materials of construction will vary according to a number of factors, including without limitation the specific embodiment of the present invention, cost and availability.

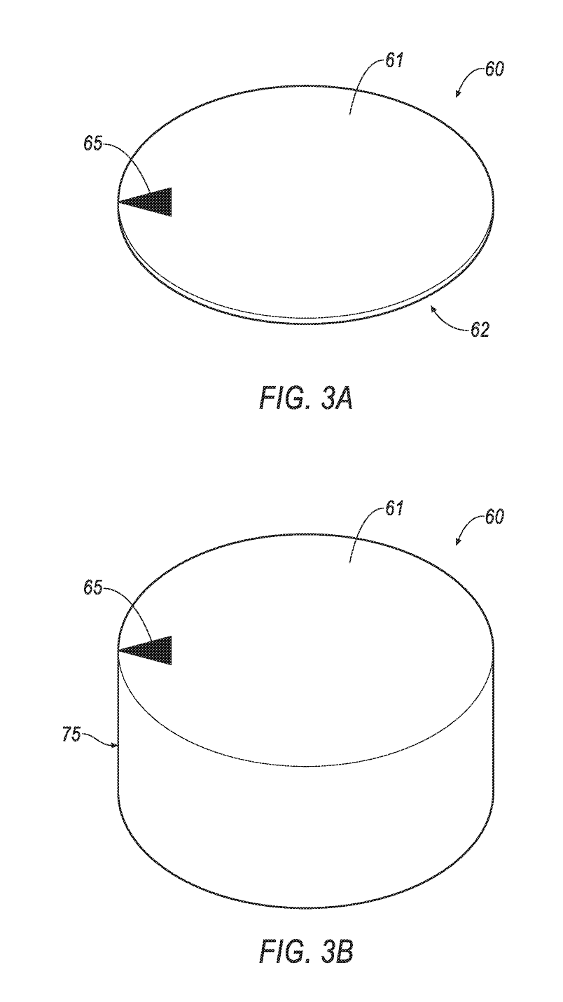

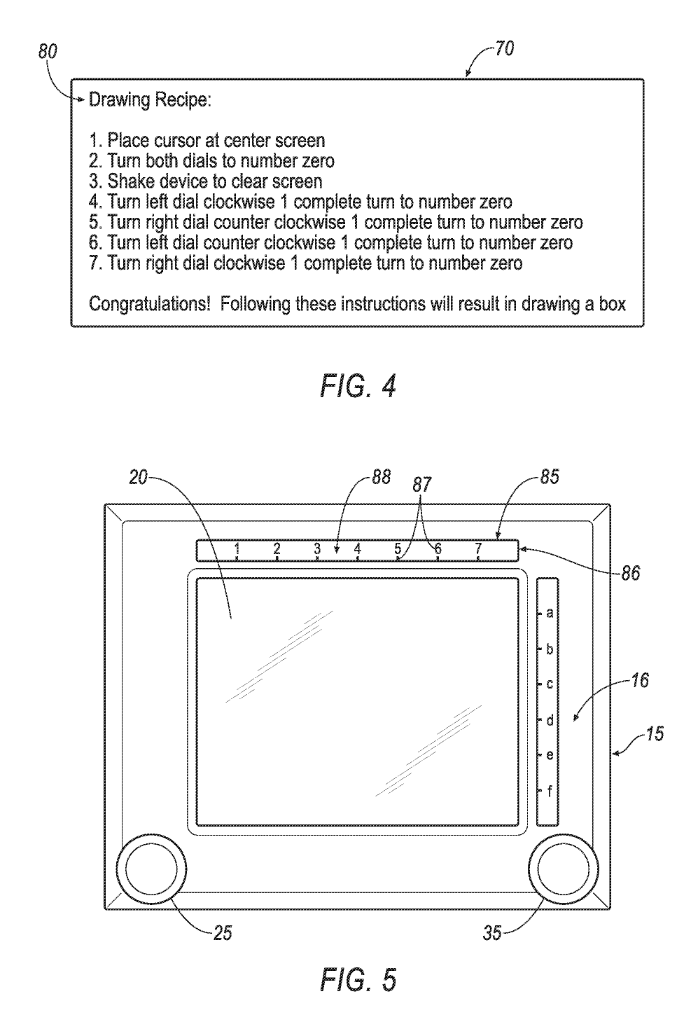

The tool of the present invention further includes at least one visual guide indicia position instruction set; generally shown as 70 in FIG. 4. The visual guide indicia position instruction set 70 includes a sequenced set of steps 80 for rotation of first and second rotatable knobs 25 and 35 based on the cooperation of the guide positioning indicia 65 and the circumferentially arranged visual guide indicia 55. Such steps 80 may include, for example, counterclockwise or clockwise rotation of one or both rotatable knobs 25 and 35 such that guide positioning indicia cooperate with circumferentially arranged visual guide indicia to indicate a position of one or both rotatable knobs corresponding to alignment of the guide positioning indicia 65 with identifiers 58. By way of non-limiting example, an instruction set 70 is provided in FIG. 4 with steps 80 to facilitate drawing a rectangle with a tracing device 10.

To use the tool of the present invention, the device 10 is first set to a start point, for example by moving the stylus to a default point on the transparent top plate, such as the center or an edge, by rotation of the rotatable knobs and clearing the screen by shaking it so that, as described above, the powder will cover places where it has been scraped off the plate in previous use, and returning the device to an upright position. For embodiments where a more precise determination of a start point is desired, the tool of the present invention may optionally include one or more start point locators 85 with adhesive layer 86 mountable and when in use mounted on top face 16 of enclosure 15 along the transparent top plate 20 and including start point location indicia 87 in the form of lines and alphabetic or numeric identifiers on top surface 88.

The tool of the present invention is then installed onto tracing device 10, with overlays 50 and position indicators 60 installed on rotatable knobs 25 and 35 and/or top face 16 of enclosure 15 depending on which embodiment of the tool is utilized. Once the tool is installed on the tracing device 10, the combination connotes an improved tracing device that includes tracing device 10. Overlays 50 and position indicators 60 are installed such that a visually readable start point, for example wherein position indicia on position indicators 60 correspond to a point of “A” or a numeric zero on the circumferentially arranged visual guide indicia, is established. The first rotatable knob 25 and second rotatable knob 35 of tracing device 10 are then rotated in accordance with the sequenced set of steps 80 for their rotation as provided for in the visual guide indicia position instruction set 70, based on the visual cooperation of circumferentially arranged visual guide indicia of the overlays and visual guide indicia of the respective visual guide indicia position indicators. This cooperation indicates rotational positions for the first and second rotatable knobs.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

That which is claimed is:

1. A tool for use with a tracing device, said tracing device including an enclosure with a top face; a transparent top plate; and first and second rotatable knobs, said tool comprising;
(i) first and second overlays each for cooperation respectively with first and second rotatable knobs, each said overlay comprising circumferentially arranged visual guide indicia on a top surface thereof;
(ii) first and second visual guide indicia position indicators, each said visual guide indicia position indicator comprising guide positioning indicia on a top surface; wherein said guide positioning indicia cooperate with said circumferentially arranged visual guide indicia to indicate rotational positions of said first and second rotatable knobs; and
(iii) at least one visually readable guide indicia position instruction set comprising a sequenced set of steps for rotation of said first and second rotatable knobs based on cooperation of said guide positioning indicia and said circumferentially arranged visual guide indicia.

2. The tool of claim 1 wherein said first and second overlays each further comprise an aperture interior to said circumferential guide indicia.

3. The tool of claim 2 wherein each said aperture is circular with a diameter larger than the diameter of said first and second rotatable knobs.

4. The tool of claim 3 wherein said first and second overlays each further comprise an adhesive layer on a bottom surface.

5. The tool of claim 3 wherein said first and second guide positioning indicators each comprise an adhesive layer on a bottom surface.

6. The tool of claim 3 wherein said first and second visual guide positioning indicators each comprise a cap mountable on each of said first and second rotatable knobs.

7. The tool of claim 1 wherein said first and second guide positioning indicators each comprise an adhesive layer on a bottom surface and are each mountable on said top face of said enclosure.

8. The tool of claim 7 wherein said first and second overlays each comprise a cap mountable on each of said first and second rotatable knobs.

9. The tool of claim 7 wherein said first and second overlays each further comprise an adhesive layer on a bottom surface.
